(19) United States
(12) Patent Application Publication
(10) Pub. No.: US 2021/0366288 A1
(43) Pub. Date: Nov. 25, 2021

(54) VEHICLE CONTROL DEVICE AND VEHICLE INCLUDING THE SAME

(71) Applicant: LG Electronics Inc., Seoul (KR)

(72) Inventors: Hansung KIM, Seoul (KR); Hyunho KI, Seoul (KR); Suho PARK, Seoul (KR); Jaeseung BAE, Seoul (KR); Changhun SUNG, Seoul (KR); Jaehwan YOON, Seoul (KR)

(21) Appl. No.: 16/490,402

(22) PCT Filed: Feb. 22, 2019
(86) PCT No.: PCT/KR2019/002228

§ 371 Date: Aug. 30, 2019

(51) Int. Cl. G08G 1/00; B60W 30/165

(52) U.S. Cl. CPC G08G 1/22; B60W 2556/45; B60W 30/165

(57) ABSTRACT

The present invention provides a vehicle control device for controlling a vehicle. The vehicle may perform autonomous driving by the vehicle control apparatus. The vehicle control device includes a communication unit configured to perform communication with vehicles positioned within a predetermined range, and a processor configured to search for a potential follow vehicle in which at least part of a moving path of the vehicle coincide with each other, and to transmit a message to the potential follow vehicle via the communication unit so that the vehicle and the potential follow vehicle are set as one group in response to the search for the potential follow vehicle.

### TECHNICAL FIELD

The present invention relates to a vehicle control device capable of controlling at least one of a vehicle and electronic components provided in the vehicle, and a vehicle including the same.

### BACKGROUND

A vehicle refers to means of transporting people or goods by using kinetic energy. Representative examples of vehicles include automobiles and motorcycles.

For safety and convenience of a user who uses the vehicle, various sensors and devices are provided in the vehicle, and functions of the vehicle are diversified.

The functions of the vehicle may be divided into a convenience function for promoting driver's convenience, and a safety function for enhancing safety of the driver and/or pedestrians.

First, the convenience function has a development motive associated with the driver's convenience, such as providing infotainment (information+entertainment) to the vehicle, supporting a partially autonomous travel function, or helping the driver ensuring a field of vision at night or at a blind spot. For example, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function is a technique of ensuring safeties of the driver and/or pedestrians, and may include various functions, such as a lane departure warning system (LDWS), a lane keeping assist system (LKAS), an autonomous emergency braking (AEB), and the like.

In addition, there is a platooning function in which a plurality of vehicles may maintain close to each other via a vehicle distance control to drive in one platoon (or group). The plurality of vehicles may exchange the moving of the vehicles and potentially abnormal situation information in the group via communication between the vehicles, and maintain the vehicle distance through the control according thereto.

When the platooning is performed, the fuel of the vehicles included in the group is saved, and since the distance between the vehicles is maintained narrow, the road occupancy rate of the vehicles is reduced and the congestion is mitigated.

The platooning may be performed through vehicle-to-everything communication (or V2X) or vehicle-to-vehicle communication (V2V). The group of the platooning includes a leader vehicle positioned at a forefront of the group and a follow vehicle following the leader vehicle. One or more follow vehicles receive driving information of the leader vehicle and move along the leader vehicle.

In general, the group is made by a group request of the follow vehicle and a group approval of the leader vehicle. Since the leader vehicle shares its own vehicle travel information, which may be called personal information, with the follow vehicle, approval is required. Requests and approvals are triggered by a user input of a passenger boarded on the vehicle.

The platooning has many advantages, but it is not popularized in that it requires requests and approvals between the passengers boarded on the leader vehicle and the follow vehicle.

### DISCLOSURE

### Technical Problem

The present invention is directed to solving the above-described problems and other problems.

The present invention is directed to providing a vehicle control device and a vehicle including the same capable of automatically forming a group without requiring a passenger's request and/or approval to perform platooning.

In addition, the present invention is directed to providing a vehicle control device and a vehicle including the same capable of efficiently performing a control in consideration of safety when generating a group or updating a group.

### Technical Solution

The present invention relates to a vehicle control device for controlling a vehicle, a vehicle including the same, and a vehicle control method for a vehicle communication system including a plurality of vehicles.

A vehicle control device according to one embodiment includes: a communication unit configured to perform communication with vehicles positioned within a predetermined range; and a processor configured to search for a potential follow vehicle in which at least part of a moving path of the vehicle coincide with each other, and to transmit a message to the potential follow vehicle via the communication unit so that the vehicle and the potential follow vehicle are set as one group in response to the search for the potential follow vehicle.

According to one embodiment, when the potential follow vehicle is in plural, the processor may assign a priority order to each of the plurality of potential follow vehicles, and set the group based on the priority order.

According to one embodiment, the processor may assign a priority order to each of the plurality of potential follow vehicles based on at least one of a position, a type, a height, a length, and a speed of each potential follow vehicle.

According to one embodiment, a group formation may be determined by the priority order.

According to one embodiment, the processor may perform communication via the communication unit so that each potential follow vehicle is included sequentially in the group according to the priority order.

According to one embodiment, the processor may determine at least one of a time and a point at which the potential follow vehicle may be included in the group, and transmit the at least one to the potential follow vehicle via the communication unit.

According to one embodiment, the processor may determine the at least one of the time and the point at which the potential follow vehicle may be included in the group in consideration of the moving path of the vehicle.

According to one embodiment, the processor may receive another vehicle information including at least one of a destination and an expected moving path of each vehicle from the vehicles positioned in the predetermined range via the communication unit, and search for the potential follow vehicle that coincides with the at least part based on the another vehicle information.

According to one embodiment, the processor may search for the potential follow vehicle that coincides with the at least part based on a road on which the vehicle is driving.

According to one embodiment, the processor may generate a platooning list including an ID of each vehicle included in the group, and generate a potential follow vehicle list including IDs of each potential follow vehicle not included in the group.

According to one embodiment, when a group request message is received from a group request vehicle, the processor may determine whether to include the group request vehicle in the group according to a predetermined condition, and selectively transmit a group approval message to the group request vehicle according to the determination result.

According to one embodiment, the processor may set at least one of a time and a point to transmit the group approval message in consideration of the moving path of the vehicle.

According to one embodiment, when a time until transmitting the group approval message remains more than a predetermined time, the processor may transmit a group pending message including at least one of a time and a point to transmit the group approval message to the group request vehicle.

According to one embodiment, when the group approval message is transmitted, the processor may control the communication unit so that the group request vehicle is positioned at a predetermined order in the group.

According to one embodiment, the processor may determine the predetermined order number based on at least one of a position, a type, a height, a length, and a speed of the group request vehicle.

According to one embodiment, the predetermined condition may be varied depending on a road on which the vehicle is driving.

According to one embodiment, the processor may ignore the group request message when the group request vehicle is included in a blacklist, and the processor adds the group request vehicle to the blacklist when a larger number of group request messages than a reference number are received from the group request vehicle during a reference time.

In addition, a vehicle control device according to one embodiment includes: a communication unit configured to perform communication with vehicles positioned within a predetermined range; and a processor configured to search for a potential follow group including at least one of a vehicle or a group coinciding with at least part of a moving path of the vehicle, and to transmit a group request message for performing platooning with the potential follow group to the potential follow group via the communication unit, wherein the processor may generate a control message so that the vehicle follows the potential follow group.

According to one embodiment, the processor may generate the control message so that the vehicle follows the potential follow group by using a lane on which the potential follow group is driving.

According to one embodiment, the processor may search for a new potential follow group in response to the potential follow group deviating from the moving path of the vehicle.

### Advantageous Effects

Effects of a vehicle control device for controlling a vehicle, a vehicle including the same, and a vehicle control method of a vehicle communication system including a plurality of vehicles in the present invention will be described as follows.

A plurality of vehicles in a predetermined situation form and release a group automatically. Since surrounding vehicles are included in the group automatically when paths are in common with each other, it is possible to set an appropriate group not only when there is a request from a passenger but also when there is no request therefrom.

Since the group is formed automatically without passenger intervention, user convenience is improved and fuel efficiency of the vehicle is increased.

### BRIEF DESCRIPTION OF THE DRAWINGS

FIG. 1 is a block diagram for describing a vehicle control device according to the present invention.

FIG. 2 is a block diagram for describing a vehicle control device for controlling a plurality of vehicles.

FIG. 3 is a flowchart for describing an operation of a leader vehicle, a follow vehicle, and a potential follow vehicle for platooning.

FIG. 4 is a flowchart for describing an operation of a leader vehicle when a plurality of potential follow vehicles is searched.

FIGS. 5A, 5B, 5C, 5D, and 6 are conceptual diagrams for describing a process of searching for a potential follow vehicle and setting a group.

FIG. 7 is a flowchart for describing a method of which a leader vehicle transmits a group approval message to a potential follow vehicle.

FIG. 8 is a flowchart for describing an operation of a leader vehicle, a follow vehicle, and a potential follow vehicle for platooning.

FIG. 9 is a flowchart for describing a method of transmitting a group pending message to a potential follow vehicle by a leader vehicle.

FIG. 10 is a flowchart for describing an operation of a leader vehicle by using a black list.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present invention may be understood as a conception including cars, motorcycles and the like. Hereinafter, the vehicle will be described based on a car.

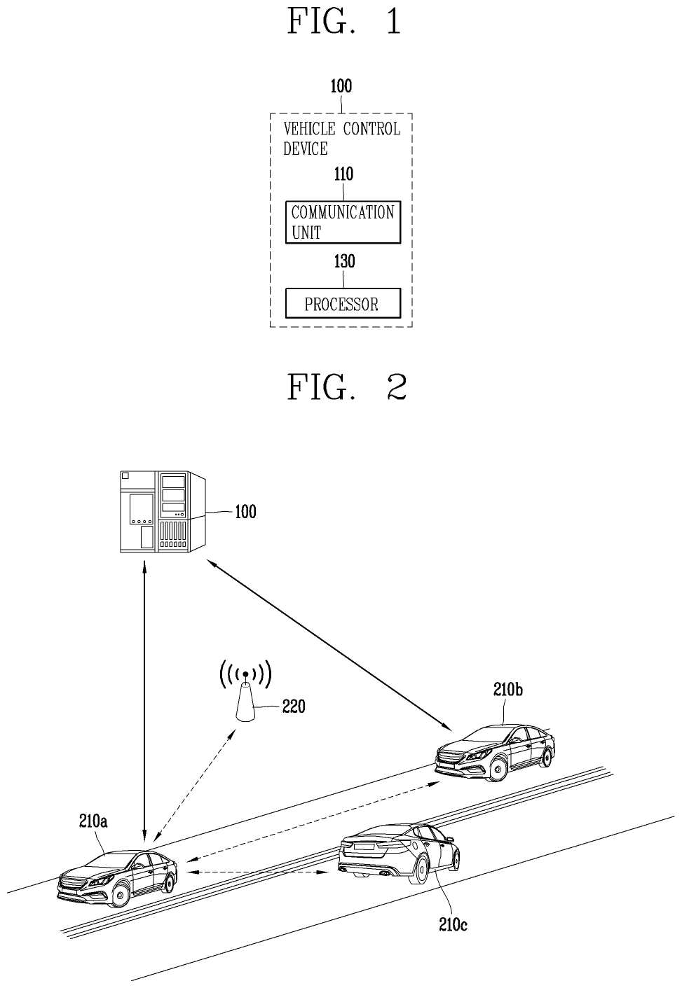

FIG. 1 is a block view illustrating a vehicle control device according to an embodiment of the present invention.

The vehicle control device refers to a device for controlling the vehicle.

For example, the vehicle control device may be a device mounted on a vehicle to perform communication through CAN communication and generate messages for controlling the vehicle and/or electric components mounted on the vehicle.

As another example, the vehicle control device may be located outside the vehicle, like a server or a communication device, and may perform communication with the vehicle through a mobile communication network. In this case, the vehicle control device can remotely control the vehicle and/or the electric components mounted on the vehicle using the mobile communication network.

The vehicle control device 100 is provided in the vehicle, and may be implemented as an independent device detachable from the vehicle or may be integrally installed on the vehicle to construct a part of the vehicle 100.

Referring to FIG. 1, the vehicle control device 100 includes a communication unit 110 and a processor 130.

The communication unit 110 is configured to perform communications with various components provided in the vehicle. For example, the communication unit 110 may receive various information provided through a controller area network (CAN). In another example, the communication unit 110 may perform communication with all devices capable of performing communication, such as a vehicle, a mobile terminal, a server, and another vehicle. This may be referred to as Vehicle to everything (V2X) communication. The V2X communication may be defined as a technology of exchanging or sharing information, such as traffic condition and the like, while communicating with a road infrastructure and other vehicles during driving.

The communication unit 110 may receive information related to the travel of the vehicle from most of electric components in the vehicle 100. The information transmitted from the electric component provided in the vehicle to the vehicle control device 100 is referred to as ‘vehicle driving information (or vehicle travel information)’.

Vehicle travel information includes vehicle information and surrounding information related to the vehicle. Information related to an inside of the vehicle with respect to a frame of the vehicle 100 may be defined as the vehicle information, and information related to an outside of the vehicle may be defined as the surrounding information.

The vehicle information refers to information related to the vehicle itself. For example, the vehicle information may include a traveling speed, a traveling direction, an acceleration, an angular velocity, a location (GPS), a weight, a number of passengers in the vehicle, a braking force of the vehicle, a maximum braking force, air pressure of each wheel, a centrifugal force applied to the vehicle, a travel mode of the vehicle (autonomous travel mode or manual travel mode), a parking mode of the vehicle (autonomous parting mode, automatic parking mode, manual parking mode), whether or not a user is present in the vehicle, and information associated with the user.

The surrounding information refers to information related to another object located within a predetermined range around the vehicle, and information related to the outside of the vehicle. The surrounding information of the vehicle may be a state of a road surface on which the vehicle is traveling (e.g., a frictional force), the weather, a distance from a front-side (rear-side) vehicle, a relative speed of a front-side (rear-side) vehicle, a curvature of a curve when a driving lane is the curve, information associated with an object existing in a reference region (predetermined region) based on the vehicle, whether or not an object enters (or leaves) the predetermined region, whether or not the user exists near the vehicle, information associated with the user (for example, whether or not the user is an authenticated user), and the like.

The surrounding information may include ambient brightness, temperature, a position of the sun, information related to nearby subject (a person, another vehicle, a sign, etc.), a type of a driving road surface, a landmark, line information, and driving lane information, and information required for an autonomous travel/autonomous parking/automatic parking/manual parking mode.

In addition, the surrounding information may further include a distance from an object existing around the vehicle to the vehicle, collision possibility, a type of an object, a parking space for the vehicle, an object for identifying the parking space (for example, a parking line, a string, another vehicle, a wall, etc.), and the like.

The vehicle travel information is not limited to the example described above and may include all information generated from the components provided in the vehicle.

Meanwhile, the processor 130 is configured to control one or more electric components provided in the vehicle using the communication unit 110.

Specifically, the processor 130 may determine whether or not at least one of a plurality of preset conditions is satisfied, based on vehicle travel information received through the communication unit 110. According to a satisfied condition, the processor 130 may control the one or more electric components in different ways.

In connection with the preset conditions, the processor 130 may detect an occurrence of an event in an electric component provided in the vehicle and/or application, and determine whether the detected event meets a preset condition. At this time, the processor 130 may detect the occurrence of the event from information received through the communication unit 110.

The application is a concept including a widget, a home launcher, and the like, and refers to all types of programs that can be run on the vehicle. Accordingly, the application may be a program that performs a function of a web browser, a video playback, a message transmission/reception, a schedule management, or an application update.

Further, the application may include a forward collision warning (FCW), a blind spot detection (BSD), a lane departure warning (LDW), a pedestrian detection (PD) A Curve Speed Warning (CSW), and a turn-by-turn navigation (TBT).

For example, the event occurrence may be a missed call, presence of an application to be updated, a message arrival, start on, start off, autonomous travel on/off, pressing of an LCD awake key, an alarm, an incoming call, a missed notification, and the like.

As another example, the occurrence of the event may be a generation of an alert set in the advanced driver assistance system (ADAS), or an execution of a function set in the ADAS. For example, the occurrence of the event may be a occurrence of forward collision warning, an occurrence of a blind spot detection, an occurrence of lane departure warning, an occurrence of lane keeping assist warning, or an execution of autonomous emergency braking.

As another example, the occurrence of the event may also be a change from a forward gear to a reverse gear, an occurrence of an acceleration greater than a predetermined value, an occurrence of a deceleration greater than a predetermined value, a change of a power device from an internal combustion engine to a motor, or a change from the motor to the internal combustion engine.

In addition, even when various electronic control units (ECUs) provided in the vehicle perform specific functions, it may be determined as the occurrence of the event.

For example, when a generated event satisfies the preset condition, the processor 130 may control the communication unit 110 to display information corresponding to the satisfied condition on one or more displays provided in the vehicle.

Meanwhile, the vehicle control device 100 may perform a function related to platooning in which a plurality of vehicles form a group.

For example, a leader vehicle of the group may transmit its own vehicle travel information to a follow vehicle included in the group. For another example, a follow vehicle in the group may perform platooning based on the vehicle travel information received from the leader vehicle. The vehicle control device provided in the follow vehicle may transmit a control message to one or more electronic components provided in the follow vehicle based on the vehicle travel information of the leader vehicle.

The communication unit 110 of the vehicle control device 100 is configured to perform communication with other vehicles positioned within a predetermined range. For example, the predetermined range may be a communicable distance for performing the platooning.

The processor 130 performs the communication with the other vehicles via the communication unit so as to perform the platooning. The processor 130 may share the vehicle travel information of its own vehicle with the other vehicle, or may receive the vehicle travel information of the other vehicle to use it for the platooning.

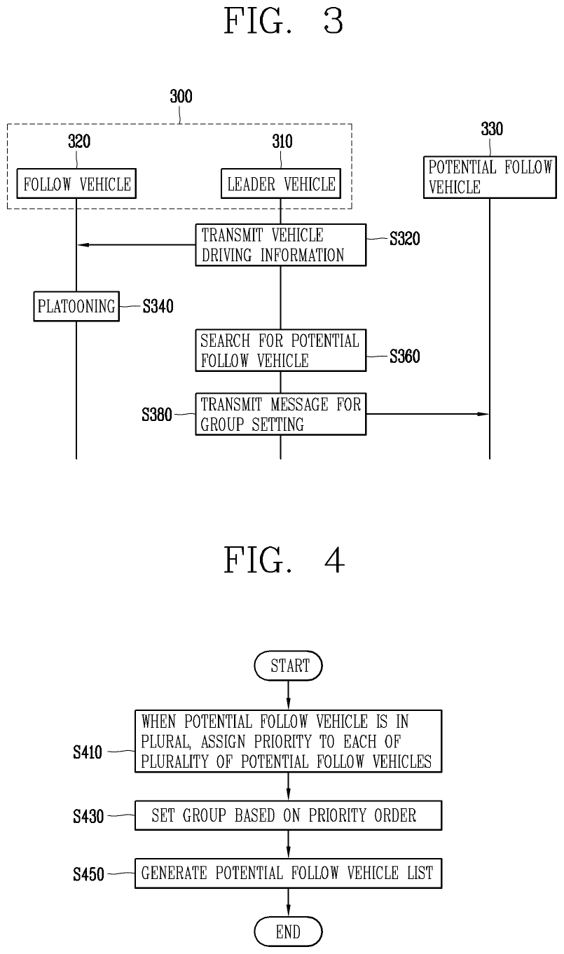

FIG. 2 is a block diagram for describing a vehicle control device for controlling a plurality of vehicles.

The vehicle control device 100 may be mounted on a vehicle to control the vehicle, and may control the vehicle remotely using a wireless network in a state in which the vehicle control device 100 is not mounted on the vehicle.

The communication unit 110 is configured to perform controller area network (CAN) communication when the vehicle control device 100 is mounted on the vehicle, and may be configured to perform wireless communication via a wireless network 220 when the vehicle control device 100 is not mounted on the vehicle. In other words, the communication unit 110 may be configured to perform different methods of communication according to the type of the vehicle control device.

The vehicle control device 100 may correspond to a server, a base station, or an infrastructure of V2I, and may communicate with one or more vehicles 210a to 210c and may generate a control message for controlling each vehicle.

For example, the vehicle control device 100 may receive first vehicle travel information generated at a first vehicle 210a from the first vehicle 210a, and generate a control message for controlling the first vehicle 210a based on the first vehicle travel information.

The control message may be associated with various control functions such as, setting a destination of the first vehicle 210a, changing a driving mode, controlling a brake, engine, motor, etc. so that speed is changed, controlling a steering device so that a driving direction is changed, or the like.

Hereinafter, an operation of the vehicle control device 100 will be described in more detail with reference to the accompanying drawings.

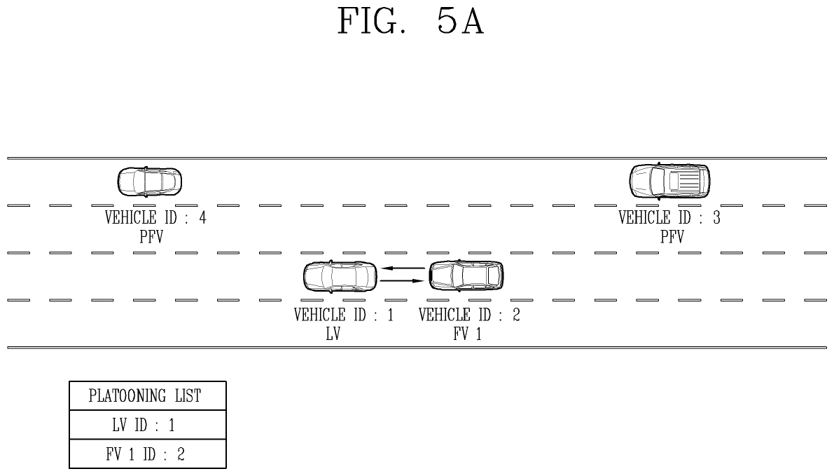

FIG. 3 is a flowchart for describing an operation of a leader vehicle, a follow vehicle, and a potential follow vehicle for platooning.

Platooning refers to driving such that the distance between a front vehicle and a rear vehicle among a plurality of vehicles consecutively positioned is maintained within a predetermined range. The plurality of vehicles drive in one group, and consist of a leader vehicle positioned at a forefront and one or more follow vehicles that follow the leader vehicle.

Vehicles 310 and 320 included in a group 300 are each provided with the above-described vehicle control device 100 in FIG. 1, and share vehicle travel information generated from each vehicle via the communication unit 110 of the vehicle control device 100.

As disclosed below, an operation of the leader vehicle 310 is performed by a processor 130 of the vehicle control device 100 provided in the leader vehicle 310 and an operation of the follow vehicle 320 is performed by the processor 130 of the vehicle control device 100 provided in the leader vehicle 310.

One group 300 includes one leader vehicle 310 and at least one follow vehicle 320.

The leader vehicle 310 is positioned at the forefront of the group 300, and transmits its own vehicle travel information to the follow vehicle 320 included in the group 300 via inter-vehicle communication (V2X) (S320).

For example, the vehicle travel information of the leader vehicle 310 including a speed, acceleration, a driving direction and the like of the leader vehicle 310 may be transmitted to the follow vehicle 320.

The follow vehicle 320 performs the platooning following (or tracking) the leader vehicle 310 by using the vehicle travel information of the leader vehicle 310 received from the leader vehicle 310 (S340).

The follow vehicle 320 performs the driving so as to maintain a predetermined distance from the preceding vehicle. For example, a speed of the follow vehicle 320 may be adjusted by accelerating or decelerating so that a distance of 10 m or less from the preceding vehicle is maintained. A speed of the follow vehicle 320 may be adjusted or a driving radius may be changed by using the vehicle travel information of the leader vehicle 310 received from the leader vehicle 310.

The follow vehicle 320 may determine a predetermined speed and a predetermined driving direction at predetermined coordinates by using the vehicle travel information of the leader vehicle 310. When the follow vehicle 320 is positioned at the predetermined coordinates, control is performed so as to have the predetermined speed and the predetermined driving direction.

The leader vehicle 310 may communicate with vehicles positioned within a predetermined range, and search for a potential follow vehicle that coincides with at least part of the moving path of the leader vehicle 310 (S360). One or more potential follow vehicles may be searched.

A potential follow vehicle 330 is defined as a vehicle that may or should be the follow vehicle 320. The potential follow vehicle 330 may be searched by the leader vehicle 310. Alternatively, any of vehicles may transmit a group request message to the leader vehicle 310 to become a potential follow vehicle 330. The leader vehicle 310 may respond to the group request message to include any of the vehicles in the potential follow vehicle 330.

The leader vehicle 310 may search for a potential follow vehicle based on sensing information sensed by a sensor provided in the leader vehicle 310. In addition, the potential follow vehicle may be searched by using the inter-vehicle communication (V2X), or the potential follow vehicle may be searched by using the telematics communication.

The leader vehicle 310 may search for a potential follow vehicle that coincides with at least part of the moving path of the leader vehicle 310 based on a road on which the leader vehicle 310 is driving. For example, when another vehicle travel on the same road in the same direction within a predetermined range is sensed, the other vehicle may be searched as a potential follow vehicle based on the sensing information.

In another example, a destination of the other vehicle and/or a moving path of the other vehicle may be received by the inter-vehicle communication, and a potential follow vehicle that coincides with at least part of the moving path of the leader vehicle 310 may be searched based on received information. The leader vehicle 310 may receive other vehicle information including at least one of a destination and an expected moving path of each vehicle from vehicles positioned within a predetermined range. In addition, based on the other vehicle information, a potential follow vehicle in which at least part of the moving path of the leader vehicle 310 coincides may be searched.

As still another example, the leader vehicle 310 may communicate with a server that receives a path of each vehicle. The leader vehicle 310 may transmit its position to the server, and the server may search for a potential follow vehicle coinciding with at least part of the moving path based on the position of the leader vehicle 310 to transmit it to the leader vehicle 310. The leader vehicle 310 may search for the potential follow vehicle based on information received from the server.

At least one of a size and shape of the predetermined range may vary depending on a speed of the leader vehicle 310. For example, when the speed of the leader vehicle 310 is within a first range, a predetermined range of a first size is set, but when the speed of the leader vehicle 310 is within a second range faster than the first range, a predetermined range of a second size smaller than the first size may be set. This is to ensure higher safety because as the speed of the vehicle increases, the risk of an accident that may occur in the vehicle increases.

The leader vehicle 310 may transmit a message so that the leader vehicle 310 and the potential follow vehicle 330 are set as one group in response to the search for the potential follow vehicle 330 (S380).

Specifically, the message may be transmitted to the potential follow vehicle 330 via the communication unit 110 of the vehicle control device 100 provided in the leader vehicle 310.

The message may include various information necessary for the potential follow vehicle 330 to be included in the group. For example, ID and security code of the leader vehicle 310 necessary for communication with the leader vehicle 310, and the vehicle travel information of the leader vehicle 310 may be included.

According to the present invention, the vehicle control device may set an appropriate group not only when there is a request from a passenger but also when there is no request therefrom. Since the group is formed automatically without passenger intervention, fuel efficiency may be increased.

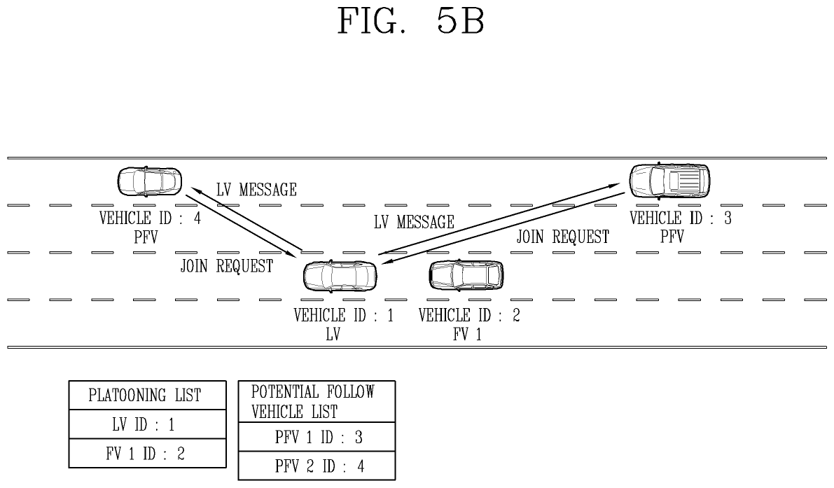

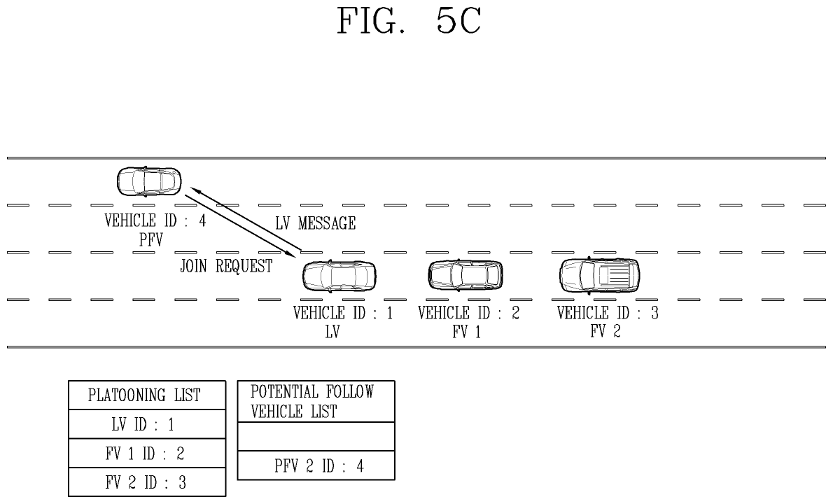

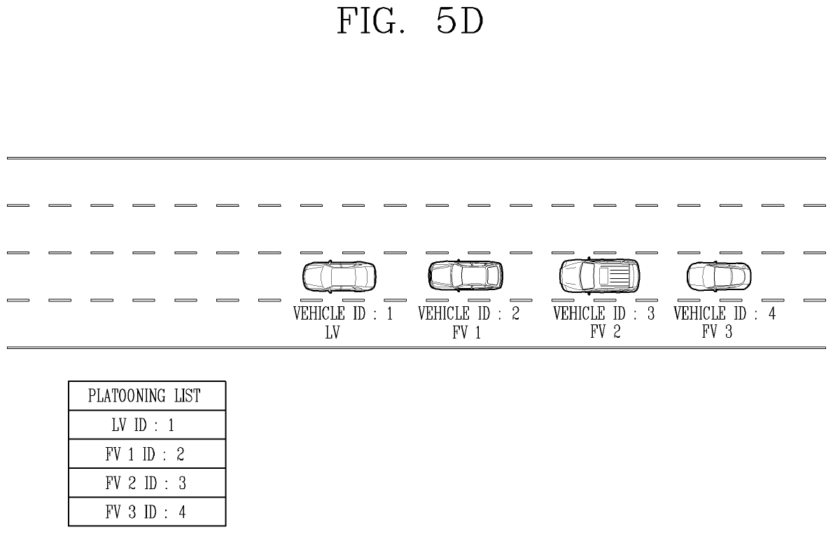

FIG. 4 is a flowchart for describing an operation of a leader vehicle when a plurality of potential follow vehicles are searched, and FIGS. 5A, 5B, 5C, 5D, and 6 are conceptual diagrams for describing a process of searching for a potential follow vehicle and setting a group.

When the potential follow vehicle is in plural, the leader vehicle 310 may assign a priority order to each of the plurality of potential follow vehicles (S410).

In order to perform platooning, a communication channel in which security between the leader vehicle 310 and the potential follow vehicle 330 is secured should be established. In addition, other vehicles not included in the group should be avoided and driving to be included in the group should be performed.

The plurality of potential follow vehicles may start the platooning simultaneously, but the leader vehicle 310 performs a related control so that the plurality of potential follow vehicles start the platooning one by one in order to secure safety. For this, when a searched potential follow vehicle is in plural, the leader vehicle 310 assigns a priority order to each of potential follow vehicles.

The leader vehicle 310 may assign a priority order to each of the plurality of potential follow vehicles based on at least one of a position, a type, a height, a length, and a speed of each of the potential follow vehicles.

The leader vehicle 310 may sense a traffic volume of each lane, and calculate a score indicating whether the plurality of potential follow vehicles are easy to join the group based on the traffic volume of each lane. The leader vehicle 310 may assign a priority order to each of the plurality of potential follow vehicles based on the calculated score. The easier joining, the higher priority order may be assigned.

When each potential follow vehicle joins the group, the leader vehicle 310 may calculate the priority order of each potential follow vehicle in the order in which fuel efficiency is maximized. For example, in a case in which when a first vehicle joins the group, the fuel efficiency is saved by A %, and when a second vehicle joins the group, the fuel efficiency is saved by B % which is smaller than A %, a first order may be assigned to the first vehicle and a second order may be assigned to the second vehicle.

When there are potential follow vehicles having the same priority order in plural, an auxiliary priority order may be recalculated in the order in which the fuel efficiency is maximized at a time of platooning. The leader vehicle 310 may calculate how much the fuel efficiency of the entire group is increased when each potential follow vehicle is included in the group. The auxiliary priority order may be assigned based on the calculation result. The plurality of potential follow vehicles having the same priority order have different orders according to the auxiliary priority order.

Next, the leader vehicle 310 may set the group based on the priority order (S430).

Each potential follow vehicle may join the group sequentially according to the priority order. The leader vehicle 310 may include in the group sequentially from the potential follow vehicle having the higher priority order.

Since the potential follow vehicle is not included in the group, the potential follow vehicle does not receive the vehicle travel information of the leader vehicle from the leader vehicle, and performs the driving unrelated to the group.

For example, when there is a first potential follow vehicle having a first priority order and a second potential follow vehicle having a second priority order, the leader vehicle determines at least one of a time and a point at which the first potential follow vehicle may be included in the group. A related message is transmitted to the first potential follow vehicle so that the first potential follow vehicle is included in the group at the determined time or point. As one example of the message, the vehicle travel information of the leader vehicle may be transmitted to the first potential follow vehicle. The first potential follow vehicle performs a preliminary platooning in order to be included in the group in response to the message, and when the first potential follow vehicle is included in the group, the platooning is performed as a follow vehicle.

Here, the preliminary platooning denotes a driving in which at least one of the vehicle speed and the driving direction is changed so that the potential follow vehicle is positioned in the order number determined by the leader vehicle in the group. For example, driving to narrow a distance from a preceding vehicle is performed. When the potential follow vehicle is included in the group formation and the distance from the preceding vehicle is within a predetermined distance, the potential follow vehicle is changed to the follow vehicle. When the potential follow vehicle is changed to the follow vehicle, the preliminary platooning is changed to the platooning.

The leader vehicle determines at least one of a time and a point at which the second potential follow vehicle may be included in the group. The leader vehicle transmits a related message to the second potential follow vehicle so that the second potential follow vehicle is included in the group at the determined time or point.

The time and point at which the second potential follow vehicle may be included in the group may be related to the changing of the first potential follow vehicle to the follow vehicle. For example, the leader vehicle may transmit the related message to the second potential follow vehicle so that the first potential follow vehicle is changed to the follow vehicle and simultaneously the second potential follow vehicle is included in the group. The second potential follow vehicle performs a preliminary platooning in order to be included in the group in response to the message, and when included in the group, the second potential follow vehicle performs the platooning is performed as a follow vehicle.

The leader vehicle 310 may generate a potential follow vehicle list (S450).

The leader vehicle 310 may generate a platooning list including IDs of the respective vehicles included in the group, and generate a potential follow vehicle list including the IDs of the respective potential follow vehicles not included in the group.

The leader vehicle 310 may manage communication channels and secure security by generating the platooning list including the IDs of the respective vehicles included in the group.

In addition, the leader vehicle 310 may generate a potential follow vehicle list to manage the potential follow vehicle. The potential follow vehicle list may include the ID and a priority order of each potential follow vehicle. When a new potential follow vehicle is searched or an existing potential follow vehicle disappears from a predetermined range, the potential follow vehicle list may be updated. When the potential follow vehicle list is updated, the priority order of at least one potential follow vehicle included in the potential follow vehicle list may be changed.

As shown in FIG. 5A, a first vehicle having a vehicle ID of 1 and a second vehicle having a vehicle ID of 2 may perform the platooning. At this point, the first vehicle may be the leader vehicle and the second vehicle may be the follow vehicle.

The leader vehicle 310 may search for the potential follow vehicle while performing the platooning. As shown in FIG. 5B, the first vehicle may use the inter-vehicle communication to search for a third vehicle having a vehicle ID of 3 and a fourth vehicle having a vehicle ID of 4 as the potential follow vehicle.

The leader vehicle 310 generates a potential follow vehicle list for the third vehicle and the fourth vehicle. At this point, the priority order for each potential follow vehicle may be determined, and the priority order may be assigned to each potential follow vehicle. For example, a first priority order may be assigned to the third vehicle, and a second priority order may be assigned to the fourth vehicle.

As shown in FIG. 5C, the preliminary platooning is performed from the third vehicle having the higher priority order, and the platooning list and the potential follow vehicle list are updated as the third vehicle is included in the group. Then, as shown in FIG. 5D, the fourth vehicle enters the group through the preliminary platooning, and then starts the platooning.

Each potential follow vehicle is sequentially included in the group according to the priority order, and the platooning according to the order number according to the priority order is performed. In other words, the group formation may be determined by the priority order.

The leader vehicle 310 may actively search for the potential follow vehicle 330 that may be the follow vehicle 320. In addition, when a plurality of potential follow vehicles join the group to start the platooning, the joining is performed sequentially according to the priority order of each potential follow vehicle, and thus a safe and efficient platooning may be performed.

The leader vehicle 310 may sense and manage the potential follow vehicle that may become or may desire to become the follow vehicle 320 by generating the potential follow vehicle list. Accordingly, an efficient group formation may be generated therethrough.

According to the present invention, the leader vehicle 310 may assign the priority order to each of the plurality of potential follow vehicles based on at least one of a position, a type, a height, a length, and a speed of each of the potential follow vehicles.

Further, it is possible to calculate the priority order, when each potential follow vehicle is included in the group, by using at least one of fuel efficiency, a time required for each potential follow vehicle to be included in the group, and a traffic volume of each lane in which each potential follow vehicle is driving.

For example, as shown in FIG. 6, among the plurality of vehicles, a third vehicle having a vehicle ID of 3 and a fourth vehicle having 4 may be searched as potential follow vehicles. A case in which the leader vehicle and the follow vehicle are driving in lane 3, the third vehicle is driving in lane 1, and the fourth vehicle is driving in lane 4 is shown as an example. A shortest distance between the third vehicle and the group is shorter than that of the fourth vehicle. However, since a plurality of vehicles are driving on the lane 2, it is easy for the fourth vehicle to be included in the group in comparison with the third vehicle.

The leader vehicle 310 may assign a higher priority order to the fourth vehicle, which is easy to include in the group, than the third vehicle, in consideration of the traffic volume and the like of each lane, collectively. That is, a first priority order may be assigned to the fourth vehicle, and a second priority order may be assigned to the third vehicle.

When there are a plurality of potential follow vehicles, the priority order is set collectively according to various conditions. Since the potential follow vehicles are included in the group sequentially according to the priority order, the fuel efficiency of the group may be increased and the group may be formed safely and quickly.

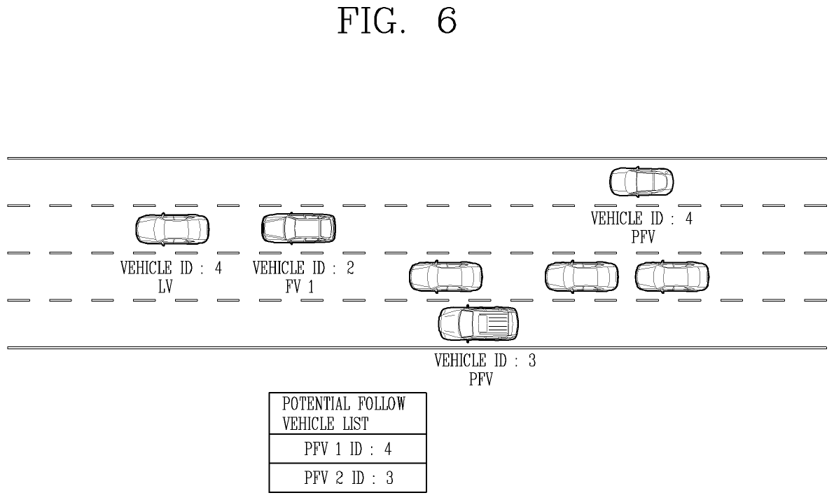

FIG. 7 is a flowchart for describing a method of which a leader vehicle transmits a group approval message to a potential follow vehicle.

The leader vehicle 310 may determine at least one of a time and a point at which the potential follow vehicle 330 may be included in the group (S710).

There may be a predetermined limitation in the group. For example, there may be a limitation on a length or a size of the group. The length of the group may be defined by a distance from one end of the leader vehicle to one end of the follow vehicle positioned at a distal end of the group. The leader vehicle may manage the follow vehicle so that the length of the group is matched to the limited length.

Due to the limited length, it may occur that a new follow vehicle may not be included in the group. In this case, it is possible to calculate a point at which at least one follow vehicle deviates from the group, and to control the potential follow vehicle to be included in the group at the calculated point.

Further, on roads where other vehicles such as curves and ramps may cause interference, the preliminary platooning may be restricted. The leader vehicle may monitor forward conditions and determine at least one of an appropriate point and time at which the preliminary platooning may be performed. In other words, at least one of the time and the point at which the potential follow vehicle 330 may be included in the group may be determined in consideration to a moving path of the leader vehicle 310.

The leader vehicle 310 may transmit at least one of the time and the point at which the potential follow vehicle may be included in the group to the potential follow vehicle via the communication unit (S730).

When at least one of the time and the point at which the potential follow vehicle 330 may be included in the group is received from the leader vehicle 310, the potential follow vehicle 330 may follow the group 300 including the leader vehicle 310. Since the platooning or the preliminary platooning is not performed, an autonomous driving that maintains a predetermined distance from the group 300 may be performed within a distance that enables communication.

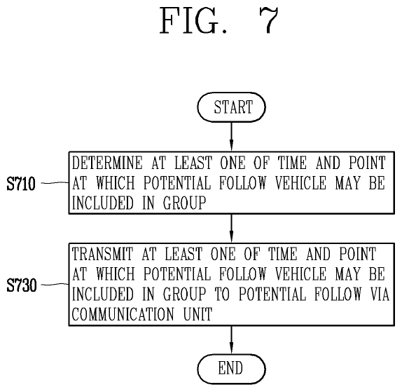

FIG. 8 is a flowchart for describing an operation of a leader vehicle, a follow vehicle, and a potential follow vehicle for platooning.

A potential follow vehicle 330 may communicate with vehicles positioned within a predetermined range. In addition, a potential follow group including at least one of a vehicle or a group that coincides with at least part of a moving path of the potential follow vehicle 330 may be searched (S810).

The potential follow vehicle 330 may transmit a group request message to the potential follow group via the communication unit in order to perform the platooning together with the potential follow group (S830).

For example, when the potential follow group is the group 300, the group request message may be transmitted to the leader vehicle 310. The group request message may include a vehicle ID that may identify the potential follow vehicle 330.

The potential follow vehicle 330 may generate a control message so as to follow the potential follow group (S830). Various electronic components provided in the potential follow vehicle 330 are operated by the control message, and autonomous driving following the potential follow group is performed.

At this point, the potential follow vehicle 330 may generate the control message to follow the potential follow group by using a driving lane on which the potential follow group is driving. For example, when the potential follow group is driving on lane 2 and the potential follow vehicle 330 is driving on lane 3, it is possible to generate a control message for changing the lane to the lane 2.

Here, the autonomous driving denotes driving in which at least one of a speed and a driving direction of the vehicle is varied by an algorithm without intervention of a driver.

When the group request message is received from the group request vehicle, that is, the potential follow vehicle 330, the leader vehicle 310 may determine whether to include the potential follow vehicle 330 in the group according to a predetermined condition (S840).

The predetermined condition may vary depending on a road on which the leader vehicle 310 is driving. The predetermined condition may vary depending on characteristics of the road under driving such as presences of a straight line region, a curve region, a highway, and the like. For example, it is not allowed to be included in a group in a ramp region that may be disturbed by other vehicles, but it may be allowed to be included in a group in the straight line region.

The predetermined condition may relate to a length and a size of the group. The leader vehicle 310 may calculate the group length when the potential follow vehicle 330 is included in the group. When the calculated group length is greater than a limited length, the potential follow vehicle 330 is not included in the group. On the other hand, when the group length is smaller than the limited length, the potential follow vehicle 330 is included in the group.

The leader vehicle 310 determines a group formation in consideration to the follow vehicle 320 and the potential follow vehicle 330, collectively (S850).

The leader vehicle 310 may determine a predetermined order number of the potential follow vehicle 330 based on at least one of a position, a type, a height, a length, and a speed of the potential follow vehicle 330. Specifically, when the potential follow vehicle joins the group, the group formation in which fuel efficiency is maximized may be determined.

The leader vehicle 310 transmits a group approval message selectively to the potential follow vehicle 330 (S860). The group approval message is transmitted selectively depending on whether the group request vehicle is included in the group 300. When the group request vehicle is determined to be included in the group 300, the group approval message is transmitted, but when the group request vehicle is determined not to be included in the group 300, the group approval message is not transmitted.

When the group approval message is transmitted, the leader vehicle 310 controls the communication unit so that the potential follow vehicle 330 is positioned in the group 300 at a predetermined order number. For example, when the order number of the follow vehicle 320 is 2 and the order number of the potential follow vehicle 330 is 3, the communication unit is controlled so that the potential follow vehicle 330 is positioned behind the follow vehicle 320. On the other hand, when the order number of the follow vehicle 320 is 3 and the order number of the potential follow vehicle 330 is 2, the communication unit is controlled so that the potential follow vehicle 330 is positioned between the leader vehicle 310 and the follow vehicle 320.

In response to the group approval message, at least one of the leader vehicle 310, the follow vehicle 320, and the potential follow vehicle 330 starts the platooning in accordance with the group formation (S870).

For example, when the order number of the follow vehicle 320 is 3 and the order number of the potential follow vehicle 330 is 2, the follow vehicle 320 may be decelerated so that the distance from the leader vehicle 310 becomes greater and the potential follow vehicle 330 is positioned between the leader vehicle 310 and the follow vehicle 320. The potential follow vehicle 330 may perform a lane change and acceleration so that the potential follow vehicle 330 is positioned between the leader vehicle 310 and the follow vehicle 320.

Although not shown in drawings, the potential follow vehicle 330 may search for a new potential follow group in response to the potential follow group deviating from the moving path of the potential follow vehicle 330. The potential follow vehicle 330 may search for the new potential follow group continuously, and perform preliminary platooning on any potential follow group that transmits a group approval message preferentially.

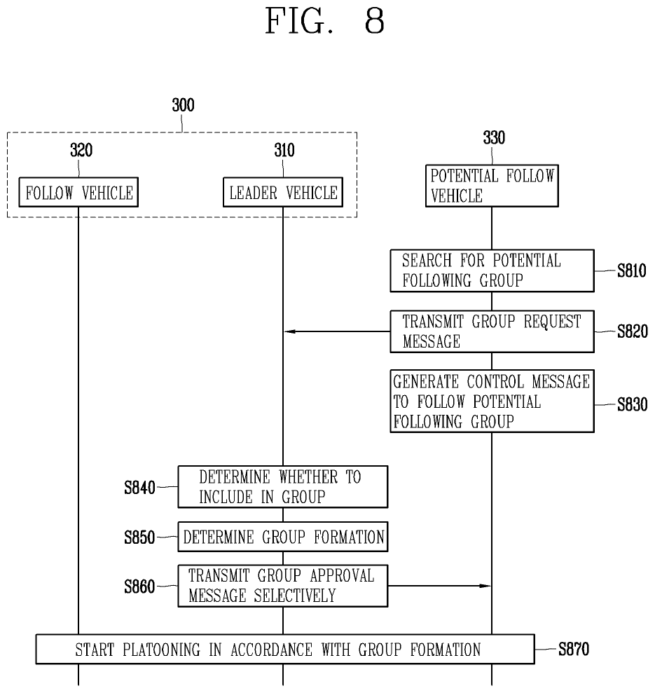

FIG. 9 is a flowchart for describing a method of transmitting a group pending message to a potential follow vehicle by a leader vehicle.

A leader vehicle 310 may determine at least one of a time and a point at which a group approval message is transmitted. When the group approval message is transmitted, a potential follow vehicle 330 performs preliminary platooning to start platooning.

The leader vehicle 310 may determine at least one of a point and a time at which the potential follow vehicle 330 may perform the preliminary platooning in consideration of a moving path of the leader vehicle 310. At least one of the point and the time may be determined by characteristics of a road included in the moving path.

When a time until transmitting the group approval message remains more than a predetermined time, the leader vehicle 310 may transmit a group pending message (S930). The group pending message may include at least one of the time and the point at which the group approval message is transmitted. The potential follow vehicle 330 may prepare for the preliminary platooning via the group pending message.

In addition, the leader vehicle 310 may transmit the group approval message at the determined time and/or point (S950). Since the group approval message is transmitted in a state in which safety is ensured, the platooning may be performed safely.

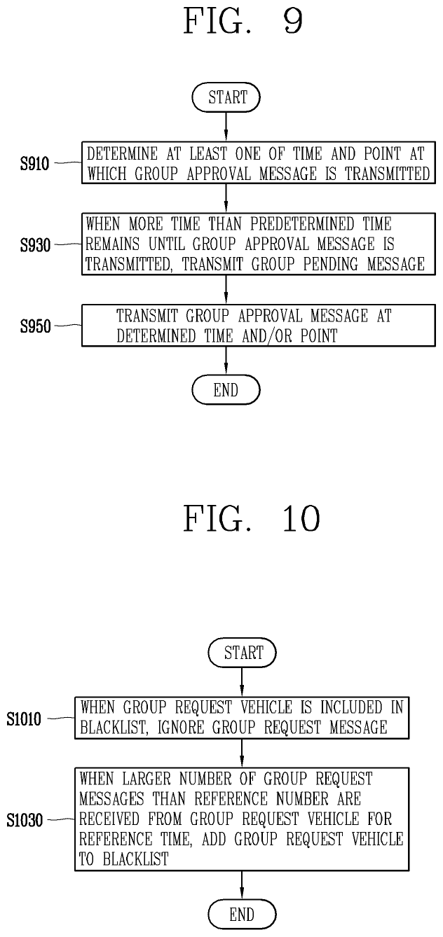

FIG. 10 is a flowchart for describing an operation of a leader vehicle by using a blacklist.

When a group request message is transmitted from a potential follow vehicle 330, a leader vehicle 310 may determine whether the potential follow vehicle 330 is included in a blacklist.

When the potential follow vehicle 330 is included in the blacklist, the group request message is ignored (S1010).

When the potential follow vehicle 330 is not included in the blacklist, the potential follow vehicle 330 is added to a potential follow vehicle list. The potential follow vehicle 330 is managed via the potential follow vehicle list until the potential follow vehicle 330 is included in the group.

When a larger number of group request messages than a reference number are received from the potential follow vehicle 330 during a reference time, the leader vehicle 310 may add the potential follow vehicle 330 to the blacklist (S1030).

When the group request message is transmitted repeatedly, since unnecessary calculations are performed repeatedly, resources of the leader vehicle 310 are wasted. The leader vehicle 310 may prevent the waste of resources of the leader vehicle 310 by adding the potential follow vehicle 330 to the blacklist.

The foregoing present disclosure may be implemented as codes (an application or software) readable by a computer on a medium written by the program. The control method of the above-described autonomous vehicle may be implemented by codes stored in a memory or the like.

The computer-readable media may include all kinds of recording devices in which data readable by a computer system is stored. Examples of the computer-readable media may include ROM, RAM, CD-ROM, magnetic tape, floppy disk, and optical data storage device, and the like, and also include a device implemented in the form of a carrier wave (for example, transmission via the Internet). In addition, the computer may include a processor or controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

1. A vehicle control device for controlling a vehicle, the vehicle control device comprising:
a communication unit configured to perform communication with vehicles positioned within a predetermined range; and
a processor configured to search for a potential follow vehicle in which at least part of a moving path of the vehicle coincide with each other, and to transmit a message to the potential follow vehicle via the communication unit so that the vehicle and the potential follow vehicle are set as one group in response to the search for the potential follow vehicle.

2. The vehicle control device of claim 1, wherein when the potential follow vehicle is in plural, the processor assigns a priority order to each of the plurality of potential follow vehicles, and sets the group based on the priority order.

3. The vehicle control device of claim 2, wherein the processor assigns a priority order to each of the plurality of potential follow vehicles based on at least one of a position, a type, a height, a length, and a speed of each potential follow vehicle.

4. The vehicle control device of claim 3, wherein a group formation is determined by the priority order.

5. The vehicle control device of claim 2, wherein the processor performs communication via the communication unit so that each potential follow vehicle is included sequentially in the group according to the priority order.

6. The vehicle control device of claim 1, wherein the processor determines at least one of a time and a point at which the potential follow vehicle is to be included in the group, and transmits the at least one to the potential follow vehicle via the communication unit.

7. The vehicle control device of claim 6, wherein the processor determines the at least one of the time and the point at which the potential follow vehicle is to be included in the group in consideration of the moving path of the vehicle.

8. The vehicle control device of claim 1, wherein the processor receives another vehicle information including at least one of a destination and an expected moving path of each vehicle from the vehicles positioned in the predetermined range via the communication unit, and searches for the potential follow vehicle that coincides with the at least part based on the another vehicle information.

9. The vehicle control device of claim 1, wherein the processor searches for the potential follow vehicle that coincides with the at least part based on a road on which the vehicle is driving.

10. The vehicle control device of claim 1, wherein the processor generates a platooning list including an ID of each vehicle included in the group, and generates a potential follow vehicle list including IDs of each potential follow vehicle not included in the group.

11. The vehicle control device of claim 1, wherein when a group request message is received from a group request vehicle, the processor determines whether to include the group request vehicle in the group according to a predetermined condition, and selectively transmits a group approval message to the group request vehicle according to the determination result.

12. The vehicle control device of claim 11, wherein the processor sets at least one of a time and a point to transmit the group approval message in consideration of the moving path of the vehicle.

13. The vehicle control device of claim 12, wherein when a time until transmitting the group approval message remains more than a predetermined time, the processor transmits a group pending message including at least one of the time and the point to transmit the group approval message to the group request vehicle.

14. The vehicle control device of claim 11, wherein when the group approval message is transmitted, the processor controls the communication unit so that the group request vehicle is positioned at a predetermined order in the group.

15. The vehicle control device of claim 14, wherein the processor determines the predetermined order number based on at least one of a position, a type, a height, a length, and a speed of the group request vehicle.

16. The vehicle control device of claim 11, wherein the predetermined condition is varied depending on a road on which the vehicle is driving.

17. The vehicle control device of claim 11, wherein the processor ignores the group request message when the group request vehicle is included in a blacklist, and the processor adds the group request vehicle to the blacklist when a larger number of group request messages than a reference number are received from the group request vehicle during a reference time.

18. A vehicle control device for controlling a vehicle, the vehicle control device comprising:
a communication unit configured to perform communication with vehicles positioned within a predetermined range; and
a processor configured to search for a potential follow group including at least one of a vehicle or a group coinciding with at least part of a moving path of the vehicle and to transmit a group request message for performing platooning with the potential follow group to the potential follow group via the communication unit, wherein the processor generates a control message so that the vehicle follows the potential follow group.

19. The vehicle control device of claim 18, wherein the processor generates the control message so that the vehicle follows the potential follow group by using a lane on which the potential follow group is driving.

20. The vehicle control device of claim 18, wherein the processor searches for a new potential follow group in response to the potential follow group deviating from the moving path of the vehicle.
